(19) United States
(12) Patent Application Publication
(10) Pub. No.: US 2022/0220279 A1
(43) Pub. Date: Jul. 14, 2022

(54) POLYLACTIC ACID COMPOSITION, METHOD FOR PRODUCING THE SAME, AND PRODUCED PRODUCT

(71) Applicants: Taichi Nemoto, Shizuoka (JP); Chiyoshi Nozaki, Tokyo (JP); Hideki Sugiura, Shizuoka (JP)

(72) Inventors: Taichi Nemoto, Shizuoka (JP); Chiyoshi Nozaki, Tokyo (JP); Hideki Sugiura, Shizuoka (JP)

(73) Assignee: Ricoh Company, Ltd., Tokyo (JP)

(21) Appl. No.: 17/605,012

(22) PCT Filed: Apr. 2, 2020
(86) PCT No.: PCT/JP2020/015163

§ 371 Date: Oct. 20, 2021

(30) Foreign Application Priority Data
Apr. 26, 2019 (JP) 2019-085659

(51) Int. Cl. C08K 3/26; C08K 3/22; C08K 3/34; C08J 9/00; C08J 5/18; C08J 9/12

(52) U.S. Cl. CPC C08K 3/26; C08K 3/22; C08K 3/346; C08J 9/0066; C08J 2367/04; C08J 9/122; C08K 2003/267; C08K 2003/2224; C08K 2003/265; C08J 5/18

(57) ABSTRACT

A polylactic acid composition includes polylactic acid and a filler. An amount of the filler in the polylactic acid composition is 50% by mass or less, and the polylactic acid in the polylactic acid composition has a weight average molecular weight (Mw) of 150,000 or more and a molecular weight distribution (Mn/Mw) of 1.5 or more but 2.0 or less.

### TECHNICAL FIELD

The present disclosure relates to a polylactic acid composition, a method for producing the polylactic acid composition, and a produced product.

### BACKGROUND ART

In recent years, polylactic acid has attracted attention. The reason for this is because the polylactic acid is one of few resins that have both the characteristic of a bioplastic (i.e., biodegradablility) and the characteristic of a biomass plastic. Therefore, materials relating to recent garbage problems have been actively developed.

Due to the low crystallization rate, the polylactic acid has the problems such as low mold processability, low heat resistance, low shock resistance, and low flexibility, and there are less commercially available products of the polylactic acid alone. Therefore, modification using an alloy with another polymer or using copolymerization is attempted. However, at least one characteristic of biodegradablility and biomass may possibly be lost depending on kinds of the resins used.

Meanwhile, addition of an inorganic filler such as a crystal nucleating agent, and nanocomposites to which an organic filler such as clay is added have been considered. In order to disperse the filler, the kneading is generally performed by utilizing shearing force in a region where the melt viscosity (elongational viscosity) of a polymer is high. However, in the case of polylactic acid, the polylactic acid has a low melt viscosity even near the melting point and has a considerably high temperature dependence. Therefore, a sufficient shearing force is not applied and dispersion of the filler is insufficient.

In order to increase the melt viscosity of polylactic acid, elongation and crosslinkage of polylactic acid using a crosslinking agent or an extension agent including urethane or a glycidyl group as a reactive group have been performed. However, these extension agents and crosslinking agents are not preferable because they are generally petroleum-derived materials and include a material having no biodegradablility.

In addition, depending on energy to be applied for dispersion (heating or stirring energy), polylactic acid is decomposed, the weight average molecular weight is decreased, and the molecular weight distribution becomes wider at a side of a low molecular weight. Therefore, even when the extension agent or the crosslinking agent is used, the melt viscosity may not be controlled as intended, due to an adverse effect by the components having a low molecular weight. Decomposition of polylactic acid results in not only a decrease in the melt viscosity but also a drastic decrease in characteristics (e.g., heat resistance and strength) of molded and processed products. Particularly, a significant influence is found in fillers having a small shape and a high cohesive force and fillers having an alkali activity and accelerating decomposition reaction of the polylactic acid.

A polymer composition having a controlled melt viscosity, which is obtained by blending polyolefin other than polylactic acid (e.g., polyethylene and polypropylene) at the time when the filler having an alkali activity is introduced into polylactic acid, has been proposed (see, for example, PTL 1). In this proposal, decomposition of the polymer composition can be suppressed, but decomposition of polylactic acid itself cannot be suppressed. In addition, there is a high possibility that blending a resin other than polylactic acid degrades biodegradablility that polylactic acid has or characteristics of biomass.

Moreover, a biodegradable resin composition, which includes polylactic acid, polyglycolic acid, and calcium carbonate particles as an ester decomposition promoter, has been proposed (see, for example, PTL 2). The filler having an alkali activity is a component that promotes decomposition at the time of disposal. However, when the filler having the alkali activity is introduced into the resin composition, decomposition of the resin is not preferable. Decomposition of the resin results in deterioration of strength, flexibility, heat resistance, and appearance such as coloring in a molded and processed product.

Therefore, there is a demand for providing a polylactic acid composition that hardly decomposes polylactic acid, has a good heat resistance, and has an excellent biodegradablility even when the filler having an alkali activity is introduced.

### CITATION LIST

### Patent Literature

PTL 1: Japanese Patent No. 6401303

PTL 2: Japanese Patent No. 5829393

### SUMMARY OF INVENTION

### Technical Problem

An object of the present disclosure is to provide a polylactic acid composition that has a good heat resistance and is excellent in biodegradablility.

### Solution to Problem

According to one aspect of the present disclosure, a polylactic acid composition includes: polylactic acid; and a filler. An amount of the filler in the polylactic acid composition is 50% by mass or less. The polylactic acid in the polylactic acid composition has a weight average molecular weight (Mw) of 150,000 or more and a molecular weight distribution (Mn/Mw) of 1.5 or more but 2.0 or less.

### Advantageous Effects of Invention

According to the present disclosure, it is possible to provide a polylactic acid composition that has a good heat resistance and is excellent in biodegradablility.

### BRIEF DESCRIPTION OF DRAWINGS

FIG. 1 is a phase diagram depicting the state of a substance depending on pressure and temperature conditions.

FIG. 2 is a phase diagram which defines a range of a compressive fluid.

FIG. 3 is a schematic view presenting one example of a continuous kneading apparatus used for producing a polylactic acid composition of the present disclosure.

FIG. 4 is a schematic view presenting another example of a continuous kneading apparatus used for producing a polylactic acid composition of the present disclosure.

### DESCRIPTION OF EMBODIMENTS

### Polylactic Acid Composition

A polylactic acid composition of the present disclosure includes: polylactic acid; and a filler. An amount of the filler in the polylactic acid composition is 50% by mass or less. The polylactic acid in the polylactic acid composition has a weight average molecular weight (Mw) of 150,000 or more and a molecular weight distribution (Mn/Mw) of 1.5 or more but 2.0 or less.

The polylactic acid composition of the present disclosure includes polylactic acid and a filler, and further includes other components if necessary.

### Polylactic Acid

The polylactic acid is “bioplastic” that has both characteristics of a biodegradable plastic and characteristics of a biomass plastic.

As defined by Japan BioPlastics Association, the “bioplastics” are a general term for “biodegradable plastics that are allowed to biodegrade by microorganisms” and “biomass plastics produced by biomass as a raw material”.

The polylactic acid is not particularly limited, and appropriately synthesized products or commercially available products may be used. The commercially available products are often a straight chain polylactic acid without a branched chain that has a weight average molecular weight (Mw) of about 200,000 and a molecular weight distribution (Mw/Mn) of about 2, and has an adjusted optical purity obtained by addition of D-lactide or meso-lactide that is an enantiomer. Hereinafter, L-lactide and enantiomers are collectively called lactide.

The commercially available product of polylactic acid is not particularly limited and may be appropriately selected depending on the intended purpose. Examples thereof include D4032 (available from Nature Works) and REVODE 190 (available from HISUN).

Generally, ring-opening polymerization of L-lactide that is a cyclic dimer of lactic acid is allowed to proceed using an initiator in the presence of a catalyst to thereby synthesize polylactic acid.

The primary structure of polylactic acid can be controlled by kinds of initiators and the amount of the initiator. More specifically, a ratio between lactide and the initiator can adjust a molecular weight, and the structure of the initiator (the number of functional groups having active hydrogen such as a hydroxyl group) can form a branched structure. Such polylactic acid that has an appropriate branched structure and has a high molecular weight is preferable because the melt viscosity becomes high.

The initiator is not particularly limited and known initiators such as alcohols and amines may be used. In the case of the alcohols, a monoalcohol, a dialcohol, or a polyhydric alcohol of an aliphatic alcohol may be used, or a saturated or unsaturated alcohol may be used.

Examples of the initiator include: monoalcohols (e.g., methanol, ethanol, propanol, butanol, pentanol, hexanol, heptanol, nonanol, decanol, lauryl alcohol, myristyl alcohol, cetyl alcohol, and stearyl alcohol); dialcohols (e.g., ethylene glycol, 1,2-propanediol, 1,3-propanediol, 1,3-butanediol, 1,4-butanediol, hexanediol, nonanediol, tetramethylene glycol, and polyethylene glycol); polyhydric alcohols (e.g., glycerol, sorbitol, xylitol, ribitol, erythritol, and triethanolamine); methyl lactate; and ethyl lactate. These may be used alone or in combination.

A catalyst used for synthesizing polylactic acid is not particularly limited and may be appropriately selected depending on the intended purpose. The catalyst may be a metal catalyst including a metal atom or an organic catalyst including no metal atom.

The metal catalyst is not particularly limited and may be appropriately selected depending on the intended purpose. Examples thereof include: tin-based compounds (e.g., tin octylate, tin dibutylate, and tin di(2-ethylhexanoate)); aluminum-based compounds (e.g., aluminium acetylacetonate and aluminum acetate); titanium-based compounds (e.g., tetraisopropyl titanate and tetrabutyl titanate); zirconium-based compounds (e.g., zirconium isopropoxide); and antimony-based compounds (e.g., antimony trioxide). These may be used alone or in combination.

In applications requiring safety and stability, an organic compound (organic catalyst) including no metal atom is suitably used. Compared to the case where ring-opening polymerization of a ring-opening polymerizable monomer is performed using the organic catalyst including no metal atom through the conventional production method, use of the organic catalyst including no metal atom as a catalyst is preferable because time required for polymerization reaction can be shortened and a method for producing polylactic acid excellent in a polymer conversion ratio can be provided. The organic catalyst is not particularly limited so long as the organic catalyst contributes to ring-opening polymerization reaction of the ring-opening polymerizable monomer, and is desorbed/reproduced through reaction with an alcohol after formation of an active intermediate with the ring-opening polymerizable monomer.

The organic catalyst is preferably a compound that functions as a nucleophilic agent having basicity, more preferably a compound including a nucleophilic nitrogen atom having basicity, still more preferably a cyclic compound including a nucleophilic nitrogen atom having basicity. Note that, the nucleophilic agent (nucleophilicity) is a chemical species (and its property) that reacts with an electrophilic reagent. The aforementioned compound is not particularly limited and may be appropriately selected depending on the intended purpose. Examples thereof include cyclic monoamines, cyclic diamines (cyclic diamine compounds having an amidine skeleton), cyclic triamine compounds having a guanidine skeleton, heterocyclic aromatic organic compounds including a nitrogen atom, and N-heterocyclic carbene. A cationic organic catalyst is used in the aforementioned ring-opening polymerization reaction. However, because hydrogen is extracted from the main chain of the polymer (backbiting), the molecular weight distribution becomes wide, and it is difficult to obtain polylactic acid having a high molecular weight.

Examples of the cyclic monoamine include quinuclidine.

Examples of the cyclic diamine include 1,4-diazabicyclo[2.2.2]octane (DABCO) and 1,5-diazabicyclo(4,3,0)-5-nonene.

Examples of the cyclic diamine compound having an amidine skeleton include 1,8-diazabicyclo[5.4.0]undec-7-ene (DBU) and diazabicyclo nonene.

Examples of the cyclic triamine compound having a guanidine skeleton include 1,5,7-triazabicyclo[4.4.0]dec-5-ene (TBD) and diphenylguanidine (DPG).

Examples of the heterocyclic aromatic organic compound including a nitrogen atom include N,N-dimethyl-4-aminopyridine (DMAP), 4-pyrrolidinopyridine (PPY), pyrrocoline, imidazole, pyrimidine, and purine.

Examples of the N-heterocyclic carbene include 1,3-di-tert-butylimidazole-2-ylidene (ITBU).

Among them, DABCO, DBU, DPG, TBD, DMAP, PPY, and ITBU are preferable because they are hardly influenced by steric hindrance and have a high nucleophilicity, or have a boiling point at which polylactic acid can be removed under reduced pressure.

Among the organic catalysts, for example, DBU is liquid at room temperature and has a boiling point. When such an organic catalyst is selected, the polylactic acid obtained can be treated under reduced pressure to almost quantitatively remove the organic catalyst from the polylactic acid. Note that, kinds of organic solvents and presence or absence of the removal treatment are determined depending on, for example, an intended use of a product.

The kinds and the amount of the organic catalyst are changed depending on a combination of the compressive fluid and the ring-opening polymerizable monomer, and cannot be sweepingly specified. However, the amount of the organic catalyst is preferably 0.01% by mole or more but 15% by mole or less, more preferably 0.1% by mole or more but 1% by mole or less, still more preferably 0.3% by mole or more but 0.5% by mole or less, relative to 100% by mole of the ring-opening polymerizable monomer. When the amount is less than 0.01% by mole, the organic catalyst is inactivated before polymerization reaction is completed, and therefore polylactic acid having an intended weight average molecular weight may not be obtained. Meanwhile, when the amount is more than 15% by mole, it may be difficult to control the polymerization reaction.

A reaction temperature of polylactic acid may be set depending on activity of the catalyst. In the case of the tin octylate, the reaction temperature is preferably 180 degrees Celsius or more. In the case of an organocatalyst, when DBU is used, the reaction temperature is preferably 60 degrees Celsius or less. The polylactic acid is preferably synthesized through solution polymerization or in a compressive fluid so that the system is not solidified.

A rate of polylactic acid is preferably 60% by mass or more, more preferably 99% by mass or more, still more preferably 99.5% by mass or more, relative to a total amount of organic matters in the polylactic acid composition. The rate of polylactic acid of less than 60% by mass is not preferable because blend or copolymerization of another component deteriorates characteristics of biomass plastics and green plastics of polylactic acid.

### Method for Measuring Rate of Polylactic Acid

The rate of the polylactic acid can be calculated from a rate of a material to be charged. If the rate of the material is unclear, for example, the following GCMS analysis is performed, and the component can be specified through comparison using a known polylactic acid composition as a standard sample. If necessary, the calculation can be performed in combination with an area ratio of spectra measured through NMR or another analysis method.

### GCMS Analysis

GCMS: QP2010, available from SHIMADZU CORPORATION; auxiliary device: Py3030D, available from Frontier Laboratories Ltd.
Separation column: Ultra ALLOY UA5-30M-0.25F, available from Frontier Laboratories Ltd.
Sample heating temperature: 300 degrees Celsius
Column oven temperature: 50 degrees Celsius (maintained for 1 minute) to temperature rising: 15° C./min to 320 degrees Celsius (6 minutes)
Ionization method: Electron Ionization (E. I) method
Detection mass range: from 25 to 700 (m/z)

### Filler

The filler is mainly divided into a filler for volume-increasing and a filler for reinforcement.

Examples of the filler for volume-increasing include calcium carbonate, talc, silica, and clay.

Examples of the filler for reinforcement include Wollastonite, potassium titanate, xonotlite, gypsum fibers, aluminum borate, MOS, aramid fibers, various fibers, carbon fibers, glass fibers, talc, mica, glass flake, polyoxybenzoyl whisker, and nanocellulose fibers.

Among the fillers, a filler having an alkali activity is suitable in terms of effects.

Examples of the filler having an alkali activity include hydroxides of an element selected from the group consisting of Ca, Mg, Al, and Zn, carbonates of an element selected from the group consisting of Ca, Mg, Al, and Zn, oxides of an element selected from the group consisting of Ca, Mg, Al, and Zn, and combinations of the hydroxide, the carbonate, and the oxide. Specific examples thereof include calcium hydroxide, calcium carbonate, calcium oxide, magnesium hydroxide, magnesium carbonate, magnesium oxide, aluminum hydroxide, aluminum carbonate, and aluminum oxide.

Calcium carbonate is used for various purposes such as fillers for reducing cost, impartment of white color, light reflection, light scattering, and anti-blocking agents.

For example, aluminum hydroxide, calcium hydroxide, hydromagnesite, dawsonite, zinc carbonate, and antimony oxide are added as a flame retardant, and calcium oxide, magnesium oxide, and zinc carbonate are added as a water absorbent, a dehumidify material, and a dehydrating material.

Other than the above, the filler is added for various purposes such as impartment of antibacterial activity, electrical conductivity, thermal conductivity, piezoelectricity, damping properties, sound insulating properties, sliding properties, heat-insulating properties, electromagnetic wave absorption, light reflection, light scattering, radiation of heat rays, flame retardant, flame proofness, protection of radioactive rays, protection of ultraviolet rays, dehumidify materials, dehydrating materials, deodorization, gas absorption, anti-blocking (prevention of pressed films), oil absorbing properties (e.g., absorption of printing ink and quick-drying properties), and water absorbing properties.

The number average particle diameter of the filler is preferably 1 micrometer or more but 10 micrometers or less. In the present disclosure, a higher degree of effect is obtained under such conditions that require energy (temperature, stirring) to be applied for kneading. Therefore, a small-particle-diameter filler having a strong cohesive force may be used.

An amount of the filler is 50% by mass or less, preferably 0.1% by mass or more but 50% by mass or less, more preferably 10% by mass or more but 50% by mass or less, still more preferably 20% by mass or more but 40% by mass or less, relative to a total amount of the polylactic acid composition. Note that, in the application method such as a master batch, those including the filler at a high concentration in an amount of 20% by mass or more are suitable.

When the amount of the filler is 50% by mass or less, the heat resistance is good.

In the present disclosure, addition of a high concentration of the filler, which requires energy (temperature, stirring) to be applied for kneading, can achieve more effects, but a low rate of polylactic acid decreases the effects of the preset disclosure.

The timing at which the filler is charged is as follows. First, a polylactic acid resin pellet and a filler are kneaded to obtain a polylactic acid composition. Second, when polylactic acid is synthesized, a filler is charged together with, for example, a monomer, and synthesis of polylactic acid and kneading may be continuously performed. In the latter case, the initial stage of the polymerization reaction is not suitable for dispersing the filler because a concentration of the monomer is high. In other words, the filler is dispersed from the late stage of the reaction in which the viscosity becomes higher toward the time when the reaction is completed.

### Weight Average Molecular Weight (Mw) of Polylactic Acid, Molecular Weight Distribution (Mw/Mn), and Amount of Residual Monomer in Polylactic Acid Composition

A weight average molecular weight (Mw), a molecular weight distribution (Mw/Mn), and an amount of a residual monomer in the polylactic acid composition have the same meanings as a weight average molecular weight (Mw), a molecular weight distribution (Mw/Mn), and an amount of a residual monomer in a produced product including the polylactic acid composition.

A weight average molecular weight (Mw) of the polylactic acid in the polylactic acid composition is 150,000 or more, preferably 150,000 or more but 500,000 or less, more preferably 200,000 or more but 500,000 or less, still more preferably 300,000 or more but 500,000 or less. When the weight average molecular weight (Mw) is 150,000 or more, the shock resistance of the produced product is good.

A molecular weight distribution (Mn/Mw) of the polylactic acid in the polylactic acid composition is 1.5 or more but 2.0 or less, preferably 1.8 or more but 2.0 or less. The molecular weight distribution of 2.0 or more means that the molecular weight distribution becomes wider compared to that of the polylactic acid before the filler is mixed, and indicates that the polylactic acid in the polylactic acid composition is decomposed. A molded product obtained by molding such a polylactic acid composition may be deteriorated in the heat resistance and the strength.

### Measurement of Weight Average Molecular Weight (Mw) and Molecular Weight Distribution (Mw/Mn) of Polylactic Acid

Measurement is performed through GPC (gel permeation chromatography) under the following conditions.
Apparatus: GPC-8020 (available from Tosoh Corporation)
Column: TSK gel SuperH5000, TSK gel SuperH4000, TSK gel SuperH3000, TSK gel SuperH2000, and TSK gel SuperH1000 (available from Tosoh Corporation)
Temperature: 40 degrees Celsius
Solvent: chloroform
Flow rate: 1.0 mL/min

A sample (1 mL) having a concentration of 0.5% by mass is injected. A molecular weight calibration curve prepared by a monodisperse polystyrene standard sample is used to calculate a number average molecular weight (Mn) and a weight average molecular weight (Mw) of polylactic acid from the molecular weight distribution of polylactic acid measured under the aforementioned conditions. The molecular weight distribution is a value obtained by dividing Mw by Mn.

An amount of the residual monomer in the polylactic acid composition is preferably 5,000 ppm or less, more preferably 1000 ppm or less. The amount of the residual monomer of 5,000 ppm or less is advantageous because the heat resistance and the strength are high.

### Measurement of Amount of Residual Monomer

An amount of a residual monomer in the polylactic acid composition is determined according to the method for measuring an amount of lactide described in “voluntary standards in connection with food packaging containers etc. formed of synthetic resin such as polyolefin, revised edition of the third edition, appendix on June in 2004, the third section, Standards of Hygienic Testing Methods, p. 13”. Specifically, a polylactic acid composition is uniformly dissolved in dichloromethane, and a mixture solution of acetone/cyclohexane is added thereto to thereby re-precipitate the polylactic acid composition. Then, the resultant supernatant is subjected to gas chromatograph (GC) with a flame ionization detector (FID), and the residual monomer (for example, lactide and glycolide) is separated and is quantified according to the internal standard method to thereby measure the amount of the residual monomer in the polylactic acid composition. Note that, the measurement of GC can be performed under the following conditions. The “ppm” in each Table represents a mass fraction.

### GC Measurement Conditions

Column: capillary column (available from J&W, DB-17MS, length: 30 m×inner diameter: 0.25 mm, film thickness: 0.25 micrometers)
Internal standard: 2,6-dimethyl-γ-pyrone
Column flow rate: 1.8 mL/min
Column temperature: maintained at 50 degrees Celsius for 1 minute, the temperature is increased at a constant speed of 25° C./min, maintained at 320 degrees Celsius for 5 minutes
Detector: hydrogen flame ionization (FID)

### Method for Producing Polylactic Acid Composition

A method of the present disclosure for producing the polylactic acid composition is a method for producing the polylactic acid composition of the present disclosure, and includes kneading the polylactic acid and the filler in a compressive fluid.

Preferably, decomposition of the polylactic acid is suppressed, while the filler is uniformly dispersed in the polylactic acid composition, as described above.

As a result of diligently studying whether the compressive fluid can be used for kneading polylactic acid and a filler, the present inventors found that the filler can be efficiently kneaded at a temperature that is lower than the melting point of the polylactic acid in the presence of the compressive fluid. The kneading at a low temperature makes it possible to suppress decomposition of the polylactic acid, and to knead the filler at a higher viscosity.

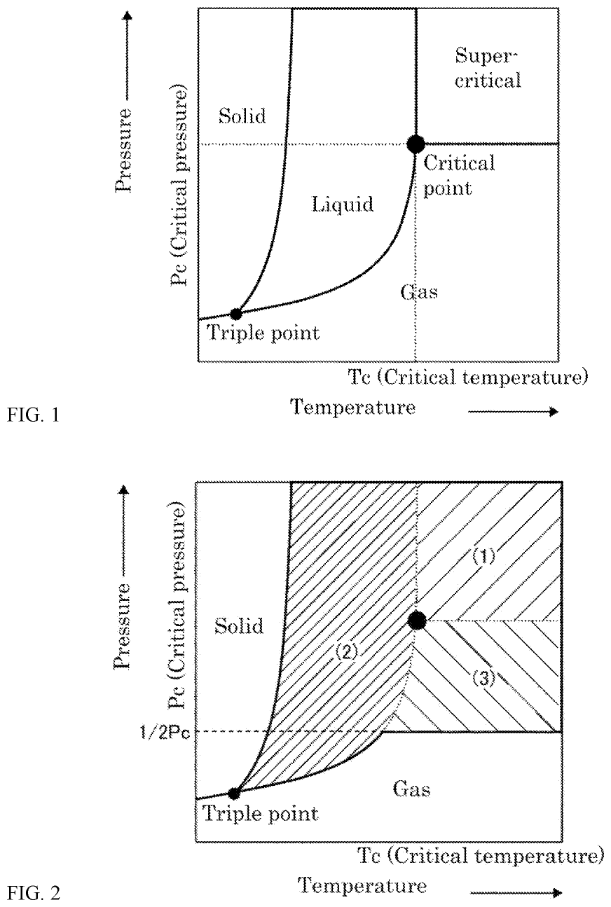

Here, FIG. 1 and FIG. 2 are used to present a compressive fluid used for producing a polylactic acid composition. FIG. 1 is a phase diagram depicting the state of a substance depending on pressure and temperature conditions. FIG. 2 is a phase diagram which defines a range of a compressive fluid. Here, the larger filled circle in FIG. 2 presents a critical point as indicated in FIG. 1. The “compressive fluid” refers to a state of a substance present in any one of the regions (1), (2) and (3) of FIG. 2 in the phase diagram presented in FIG. 1.

In such regions, the substance is known to have extremely high density and show different behaviors from those shown at normal temperature and normal pressure. Note that, the substance is a supercritical fluid when it is present in the region (1). The supercritical fluid is a fluid that exists as a non-condensable high-density fluid at temperature and pressure exceeding a limiting point (critical point) at which a gas and a liquid can coexist and that does not condense even when it is compressed. When the substance is in the region (2), the substance is a liquid, but it is a liquefied gas obtained by compressing a substance existing as a gas at normal temperature (25 degrees Celsius) and normal pressure (1 atm). When the substance is in the region (3), the substance is in the state of a gas, and is a high-pressure gas of which pressure is ½ or more of the critical pressure (Pc), i.e. ½ Pc or higher.

Examples of a substance that can be used in the state of the compressive fluid include carbon monoxide, carbon dioxide, dinitrogen monoxide, nitrogen, methane, ethane, propane, 2,3-dimethylbutane, ethylene, and dimethyl ether. Among them, carbon dioxide is preferable because the critical pressure and critical temperature of carbon dioxide are about 7.4 MPa and about 31 degrees Celsius, respectively, and thus a supercritical state of carbon dioxide is easily generated. In addition, carbon dioxide is non-flammable, and therefore it is easily handled. These compressive fluids may be used alone or in combination.

The solubility of the compressive fluid varies depending on combination of a resin and a compressive fluid. For example, when polylactic acid and carbon dioxide are combined, a supply amount of the compressive fluid is preferably 2% by mass or more but 20% by mass or less, more preferably 3% by mass or more but 10% by mass or less. When the supply amount of carbon dioxide is less than 2% by mass, an effect of plasticization is limited. When the supply amount of carbon dioxide is more than 20% by mass, phase separation between carbon dioxide and polylactic acid occurs, and uniform kneading cannot be performed in some cases.

### Kneading Apparatus

As the kneading apparatus, a continuous process may be employed or a batch process may be employed. However, a reaction process is preferably appropriately selected by considering efficiency of an apparatus, characteristics of a product, and quality.

Because viscosity suitable for kneading can be achieved, a single screw extruder, a twin screw extruder, a kneader, a screw-less basket-shaped stirring vessel, BIVOLAK (available from Sumitomo Heavy Industries, Ltd.), N-SCR (available from Mitsubishi Heavy Industries, Ltd.), and tube-shaped polymerization vessel equipped with spectacle-shaped blade (available from Hitachi, Ltd.), lattice-blade or Kenix-type, or Sulzer-type SMLX-type static mixer can be used as the kneading apparatus. In terms of color tone, examples of the kneading apparatus include a finisher that is a self-cleaning-type polymerization apparatus, N-SCR, and a twin-screw extruder. Among them, a finisher and N-SCR are preferable in terms of production efficiency, color tone of a resin, stability, and heat resistance.

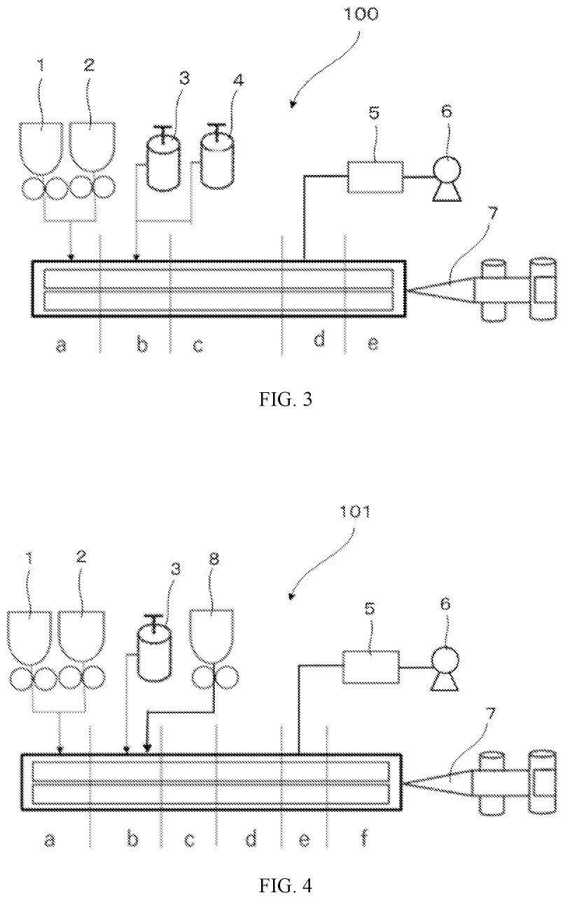

As presented in FIG. 3, a continuous kneading apparatus 100 uses a twin screw extruder (available from JSW) (screw caliber: 42 mm, L/D=48), and includes (raw material mixing·melting area a, resin pellet supplying tank 1, filler supplying tank 2), (compressive fluid supplying area b, compressive fluid supplying tank (No. 1) 3, compressive fluid supplying tank (No. 2) 4), kneading area c, compressive fluid removing area d, molding processing area e, and T-die 7. In FIG. 3, the reference numeral 5 presents a trap and the reference numeral 6 presents a vacuum pump. A compressive fluid (liquid material) is supplied by a metering pump. Solid raw materials such as the resin pellet and calcium carbonate are supplied by a quantitative feeder.

### Raw Material Mixing·Melting Area

In the raw material mixing·melting area, a polylactic acid resin pellet and a filler are mixed, and the temperature is increased. The heating temperature is set to a temperature that is equal to or higher than the polylactic acid-melting temperature, which makes it possible to uniformly mix the mixture with a compressive fluid in a subsequent area where the compressive fluid is to be supplied.

### Compressive Fluid Supplying Area

The polylactic acid resin pellet becomes melted through warming, and the compressive fluid is supplied in the state that the filler is wetted, to thereby plasticize the melted resin.

### Kneading Area

The temperature in the kneading area is set so that viscosity suitable for kneading the filler is achieved. The setting temperature is not particularly limited because it varies depending on the specification of a reaction apparatus, kinds of resins, the structures of the resin, and the molecular weight thereof. However, in the case of a commercially available polylactic acid having a weight average molecular weight (Mw) of about 200,000, the kneading is generally performed at the melting point of polylactic acid+(10 degrees Celsius to 20 degrees Celsius). Meanwhile, in the present disclosure, the kneading is performed at the melting point of polylactic acid−(20 degrees Celsius to 80 degrees Celsius), more preferably at the melting point of polylactic acid−(30 degrees Celsius to 60 degrees Celsius). Simply, the temperature may be set by referring to, for example, current values of stirring power of the apparatus. However, it can be said that these setting values are generally unreachable ranges unless a compressive fluid is used.

### Compressive Fluid Removing Area

After the kneading, the pressure is released to thereby remove the compressive fluid. At that time, the temperature is preferably set to a temperature that is equal to or higher than the melting temperature of the resin through warming.

### Molding Processing Area

A produced product of the present disclosure can be produced by applying the conventionally known production method used for a thermoplastic resin. In the case of processing into a sheet, a T-die is used.

### Produced Product

A produced product of the present disclosure includes the polylactic acid composition of the present disclosure, and further includes other components if necessary.

Examples of the produced product include molded products, sheets, films, particles, fibers, and foamed bodies. Among them, when calcium carbonate as the filler is used, white sheets and white molded products that utilize color tome of calcium carbonate are preferable.

### Molded Product

The molded product is a product obtained by processing the polylactic acid composition of the present disclosure using a mold. The concept of the molded product includes not only molded products as one piece but also components including molded products such as a grip of a tray, and products provided with a molded product such as a tray to which a grip is attached.

A processing method using a mold is not particularly limited and the conventionally known processing methods of a thermoplastic resin can be used. Examples thereof include injection molding, vacuum molding, pressure forming, vacuum pressure forming, and press molding.

The molded product can be obtained by melting the polylactic acid composition of the present disclosure and then subjecting the melted product to injection molding. In addition, the molded product can be obtained by subjecting a sheet formed of the polylactic acid composition of the present disclosure to press molding using a mold for molding, followed by shaping (imparting a shape).

The processing conditions at the time of the shaping are appropriately determined depending on, for example, kinds of the polylactic acid composition of the present disclosure and apparatuses. For example, when the sheet formed of the polylactic acid composition of the present disclosure is subjected to press molding for the shaping using a mold for molding, a temperature of the mold can be 100 degrees Celsius or more but 150 degrees Celsius or less. When the shaping is performed through injection molding, processing through injection molding can be performed by injecting, to a mold, the polylactic acid composition of the present disclosure that has been heated to 150 degrees Celsius or more but 250 degrees Celsius or less, and setting a temperature of the mold to about 20 degrees Celsius or more but about 80 degrees Celsius or less.

The conventional polylactic acid composition including calcium carbonate has problems in terms of physical properties of the sheet (e.g., flexibility and strength of the sheet) and brightness because calcium carbonate is insufficiently dispersed.

The molded product that is molded using the polylactic acid composition of the present disclosure is excellent in physical properties and brightness. Therefore, the molded product can widely be applied to applications to, for example, industrial materials, daily necessaries, agricultural products, foods, pharmaceuticals, sheets of cosmetics, packaging materials, and trays.

The molded product is useful for applications that utilize biodegradablility of the polylactic acid composition of the present disclosure, particularly for packaging materials used for foods, cosmetics, and medical sheets such as pharmaceuticals. Further improvement in performances can be expected by achievement of a thinned film achieved by improving dispersibility of the filler.

### Particles

Examples of a method for forming the polylactic acid composition of the present disclosure into particles include a method where the polylactic acid composition of the present disclosure is pulverized through the conventionally known method.

A particle diameter of the particles is not particularly limited and may be appropriately selected depending on the intended purpose. However, the particle diameter thereof is preferably 1 micrometer or more but 50 micrometers or less.

When the particles are a toner for electrophotography, a mixture obtained by mixing a colorant and hydrophobic particles in a polylactic acid composition is prepared. The mixture may include other additives in addition to a binder resin, the colorant, and the hydrophobic particles. Examples of the other additives include a release agent and a charge-controlling agent. A step of mixing an additive may be performed concurrently with polymerization reaction. Alternatively, the additive may be added upon melting and kneading at the post-process after the polymerization reaction or after the polymerization product is extracted.

### Film

The film is a product, which is obtained by forming the polylactic acid composition of the present disclosure into a thin film, and has a thickness of less than 250 micrometers. The film is produced by subjecting the polylactic acid composition of the present disclosure to stretch forming.

In this case, the stretch forming method is not particularly limited. However, the uniaxial stretch forming method that is applied to stretch forming of commodity plastics, and simultaneous or sequential biaxial stretch forming method (e.g., the tubular method and the tenter method) can be used.

The film is generally formed within the temperature range of from 150 degrees Celsius through 280 degrees Celsius. The formed film is subjected to uniaxial or biaxial stretch forming through, for example, the roll method, the tenter method, or the tubular method. The stretching temperature is preferably from 30 degrees Celsius through 110 degrees Celsius, more preferably from 50 degrees Celsius through 100 degrees Celsius. Generally, the stretching ratios in the longitudinal direction and the horizontal direction are each preferably from 0.6 folds through 10 folds. After the stretching, a heat treatment such as a process of blowing hot air, a process of emitting infrared rays, a process of emitting microwaves, and a process of bringing the resultant into contact with a heat roll may be performed.

Such stretch forming methods make it possible to obtain various stretch films such as stretch sheets, flat yarn, stretch tape, stretch bands, tape with stripes, and split yarn. A thickness of the stretch film is not particularly limited and may be appropriately selected depending on the intended purpose. However, the thickness thereof is preferably 5 micrometers or more but less than 250 micrometers.

The formed stretch film may be subjected to a secondary processing for the purpose of imparting surface functions such as a chemical function, an electrical function, a magnetic function, a mechanical function, friction/abrasion/lubrication functions, an optical function, a thermal function, and a biocompatible function. Examples of the secondary function include emboss processing, painting, adhesion, printing, metallization (e.g., plating), machining, and surface treatments (e.g., a charge-preventing treatment, a corona-discharging treatment, a plasma treatment, a photochromism treatment, physical vapor deposition, chemical vapor deposition, and coating).

The stretch film can widely be applied to applications to, for example, daily necessaries, packaging materials, pharmaceuticals, materials of electrical apparatuses, housings of household appliances, and materials of automobiles.

### Sheet

The sheet is a product, which is obtained by forming the polylactic acid composition of the present disclosure into a thin film, and has a thickness of 250 micrometers or more.

The sheet can be produced by applying, to the polylactic acid composition of the present disclosure, the conventionally known method for producing a sheet that has been used for thermoplastic resins. The method for producing the sheet is not particularly limited and may be appropriately selected depending on the intended purpose. Examples thereof include the T-die method, the inflation method, and the calendaring method.

The process conditions at the time of processing into the sheet are not particularly limited and may be appropriately determined depending on, for example, kinds of the polylactic acid composition and apparatuses. For example, when polylactic acid is processed through the T-die method, the sheet processing can be performed using an extruder having a T-die mounted at the outlet, by extruding, from the T-die, the polylactic acid composition that has been heated to preferably 150 degrees Celsius or more but 250 degrees Celsius or less.

### Fiber

The polylactic acid composition of the present disclosure can be applied to fibers such as monofilament and multifilament. The concept of the fibers includes not only single fibers such as monofilament but also intermediate products constituted with fibers such as woven fabric and nonwoven fabric, and products including woven fabrics or nonwoven fabrics (e.g., masks).

In the case of monofilament, the polylactic acid composition of the present disclosure is subjected to melt spinning, cooling, and drawing for fibrillization through the conventionally known method, to thereby produce the fibers. Depending on applications, a coating layer may be formed on the monofilament through the conventionally known method, and the coating layer may include, for example, an antibacterial agent and a colorant. In the case of nonwoven fabrics, the polylactic acid composition of the present disclosure is subjected to melt spinning, cooling, drawing, fiber spreading, deposition, and a heat treatment through the conventionally known method, to thereby produce the nonwoven fabrics.

### Foamed Body

The foamed body is obtained by allowing the polylactic acid composition of the present disclosure to foam. The concept of the foamed body includes not only foamed bodies as one piece such as foamed resins but also components including foamed bodies such as heat insulating materials and soundproofing materials, and products including foamed bodies such as construction materials.

One example of a method for producing the foamed body is, for example, a method for obtaining the foamed body by utilizing gasification of a compressive fluid in a polylactic acid composition generated when the polylactic acid composition plasticized or dissolved in the compressive fluid is decreased in temperature and pressure. It is believed that when the compressive fluid in the polylactic acid composition of the present disclosure is released to the atmosphere, the compressive fluid is diffused at a rate of from 10⁻⁵/sec through 10⁻⁶/sec. When the pressure is released, a decrease in temperature may occur because of constant enthalpy, and controlling the cooling rate may be difficult in some cases. Even in this case, when the elasticity of a polymer at the time of releasing the pressure to the atmosphere is large, cells are maintained to thereby form the foamed body.

In the case of obtaining the foamed body, a predetermined amount of the polylactic acid composition plasticized or dissolved in a compressive fluid is directly injected into a mold for molding, the pressure is reduced, and then the polylactic acid composition is heated and molded to thereby produce a molded product of the foamed body. Examples of the heating manner include steam, conductive heat, radiant heat, and microwave. In this case, the polylactic acid composition is heated to about 100 degrees Celsius through about 140 degrees Celsius by these heating manners, preferably heated to from 110 degrees Celsius through 125 degrees Celsius by steam for foam molding.

In addition, the general method for producing foamed plastic can be applied to the polylactic acid composition of the present disclosure, to thereby produce the foamed body. In this case, a resin composition obtained by adding a desired additive such as a modifier or a nucleating agent to the polylactic acid composition of the present disclosure is extruded using the general melt-extruder to thereby obtain strand. Next, a pelletizer is used to obtain pellets or particles from the strand obtained (step of forming particles). The pellets or the particles are charged into an autoclave and are charged into a gas phase or a liquid phase such as water or pure water. Then, any common additive such as a dispersing agent, a fusion preventing agent, or an adhesion preventing agent is used to prepare a dispersion liquid of resin particles. Moreover, the dispersion liquid of resin particles is foamed using a volatile foaming agent to thereby obtain foamed particles (foaming step). The particles are exposed to the atmosphere and the air is permeated into cells of the particles, and moisture attached to the particles is removed if necessary (aging step). Then, the foamed particles are filled into a closed type mold provided with small pores or slits and are heated and foamed. As a result, a produced product in which individual particles are integrally fused can be obtained.

The foamed body obtained can widely be applied to applications to, for example, cushioning materials, heat insulating materials, soundproofing materials, and vibration damping materials.

### EXAMPLES

Examples of the present disclosure will be described hereinafter. However, the present disclosure should not be construed as being limited to these Examples.

### Example 1

The continuous kneading apparatus 100 presented in FIG. 3 was used to supply polylactic acid and a filler so that the total of the flow rate of polylactic acid and the flow rate of the filler would be 10 kg/hr. The flow rate of polylactic acid A (available from Nature Works, 4032D, melting point: 168 degrees Celsius) as polylactic acid was 9 kg/hr, and the flow rate of magnesite (available from Konoshima Chemical Co., Ltd., MS-S, number average particle diameter: 1.2 micrometers) as the filler was 1 kg/hr. As a compressive fluid, 0.9 kg/h (corresponds to 10% by mass relative to polylactic acid) of carbon dioxide was supplied thereto and the resultant was kneaded to thereby obtain a polylactic acid composition and a sheet.

Temperatures of the respective zones were set as follows: the raw material mixing·melting area a and the compressive fluid supplying area b: 190 degrees Celsius; the kneading area c: 130 degrees Celsius; the compressive fluid removing area d: 190 degrees Celsius; and the molding processing area e: 190 degrees Celsius. Pressures of the respective zones were set as follows: from the compressive fluid supplying area b to the kneading area c: 10.0 MPa; the compressive fluid removing area d: 0.5 MPa; and the T-die 7: 5 MPa. A thickness of the sheet was set to 300 micrometers. Note that, a compressive fluid supplying tank (No. 2) 4 in FIG. 3 was not used.

### Example 2

A polylactic acid composition and a sheet were obtained in the same manner as in Example 1 except that the polylactic acid used in Example 1 was changed to polylactic acid B (available from HISUN, REVODE 190, melting point: 178 degrees Celsius).

### Examples 3 and 4

A polylactic acid composition and a sheet were obtained in the same manner as in Example 1 except that the filler used in Example 1 was changed to the filler as presented in Table 1 (see below).
Magnesium hydroxide (available from Konoshima Chemical Co., Ltd., MAGSEEDS N, number average particle diameter: 1.3 micrometers)
Precipitated calcium carbonate (available from Shiraishi Kogyo Kaisha, Ltd., brilliant 15, number average particle diameter: 0.15 micrometers)

### Example 5

A polylactic acid composition and a sheet were obtained in the same manner as in Example 1 except that the filler used in Example 1 was changed to talc (available from NIPPON TALC Co., Ltd., SG-95, number average particle diameter: 2.5 micrometers) presented in Table 1 and the set pressure in the kneading step was changed as presented in Table 1. Note that, talc is a filler that has no alkali activity.

### Examples 6 and 7, Comparative Example 1, and Comparative Example 2

A polylactic acid composition and a sheet were obtained in the same manner as in Example 1 except that the set temperature and the set pressure in the kneading step were changed as presented in Table 2 and Table 4. Note that, a compressive fluid is not used in Comparative Example 1.

### Examples 8, 9, 10, 12, and 13, and Comparative Examples 3 and 4

A polylactic acid composition and a sheet were obtained in the same manner as in Example 7 except that the feed ratio (polylactic acid/filler) (% by mass) was changed to the following: 99.5/0.5 (Example 8), 80/20 (Example 9), 60/40 (Example 10), 50/50 (Example 12), 99.9/0.1 (Example 13), 30/70 (Comparative Example 3), and 40/60 (Comparative Example 4) as presented in Table 2 to Table 4.

### Example 11

A polylactic acid composition and a sheet were obtained in the same manner as in Example 7 except that the compressive fluid used in Example 7 was changed to a compressive fluid obtained by mixing carbon dioxide and dimethyl ether at a ratio of 8:2 using a compressive fluid supplying tank (No. 1) 3 and a compressive fluid supplying tank (No. 2) 4, the temperature and the pressure in the kneading step were changed to 80 degrees Celsius and 15 MPa, respectively.

Next, characteristics of Examples 1 to 13 and Comparative Examples 1 to 4 were evaluated in the following manners. Results are presented in Table 1 to Table 4.

### Method for Measuring Rate of Polylactic Acid

The rate of the polylactic acid can be calculated from a rate of a material to be charged. If the rate of the material is unclear, for example, the following GCMS analysis is performed, and the component can be specified through comparison using a known polylactic acid composition as a standard sample. If necessary, the calculation can be performed in combination with an area ratio of spectra measured through NMR or another analysis method.

### Conditions of GCMS

GCMS: QP2010, available from SHIMADZU CORPORATION; auxiliary device: Py3030D, available from Frontier Laboratories Ltd.
Separation column: Ultra ALLOY UA5-30M-0.25F, available from Frontier Laboratories Ltd.
Sample heating temperature: 300 degrees Celsius
Column oven temperature: 50 degrees Celsius (maintained for 1 minute) to temperature rising: 15° C./min to 320 degrees Celsius (6 minutes)
Ionization method: Electron Ionization (E. I) method
Detection mass range: from 25 to 700 (m/z)

### Measurement of Weight Average Molecular Weight Mw and Molecular Weight Distribution (Mw/Mn) of Polylactic Acid in Polylactic Acid Composition

Measurement was performed through GPC (gel permeation chromatography) under the following conditions.
Apparatus: GPC-8020 (available from Tosoh Corporation)
Column: TSK gel SuperH5000, TSK gel SuperH4000, TSK gel SuperH3000, TSK gel SuperH2000, and TSK gel SuperH1000 (available from Tosoh Corporation)
Temperature: 40 degrees Celsius
Solvent: chloroform
Flow rate: 1.0 mL/min

A sample (1 mL) having a concentration of 0.5% by mass was injected. A molecular weight calibration curve prepared by a monodisperse polystyrene standard sample was used to calculate a number average molecular weight Mn and a weight average molecular weight Mw of polylactic acid from the molecular weight distribution of polylactic acid measured under the aforementioned conditions. The molecular weight distribution is a value obtained by dividing Mw by Mn.

### Amount of Residual Monomer

An amount of a residual monomer in the polylactic acid composition was determined according to the method for measuring an amount of lactide described in “voluntary standards in connection with food packaging containers etc. formed of synthetic resin such as polyolefin, revised edition of the third edition, appendix on June in 2004, the third section, Standards of Hygienic Testing Methods, p. 13”. Specifically, a polylactic acid composition was uniformly dissolved in dichloromethane, and a mixture solution of acetone/cyclohexane was added thereto to thereby re-precipitate the polylactic acid composition. Then, the resultant supernatant was subjected to gas chromatograph (GC) with a flame ionization detector (FID), and the residual monomer (for example, lactide and glycolide) was separated and was quantified according to the internal standard method to thereby measure the amount of the residual monomer in the polylactic acid composition. Note that, the measurement of GC can be performed under the following conditions. The “ppm” in each Table represents a mass fraction.

### GC Measurement Conditions

Column: capillary column (available from J&W, DB-17MS, length: 30 m×inner diameter: 0.25 mm, film thickness: 0.25 micrometers)
Internal standard: 2,6-dimethyl-γ-pyrone
Column flow rate: 1.8 mL/min
Column temperature: maintained at 50 degrees Celsius for 1 minute, the temperature was increased at a constant speed of 25° C./min, maintained at 320 degrees Celsius for 5 minutes
Detector: hydrogen flame ionization (FID)

### Evaluation of Heat Resistance of Produced Product

Each of the prepared sheets was subjected to the test of deflection temperature under load according to the JIS K 7191. Here, the measurement was performed under the following conditions: the distance between fulcrums: 100 mm; the rate of increasing temperature: 2° C./min; and the bending stress: 0.45 MPa.

The evaluation result of the sheet 4032D (available from Nature Work) was compared with that of the prepared sheet. When the deflection temperature of the prepared sheet was equal to or higher than the deflection temperature of the sheet 4032D, the heat resistance was considered to be “A”. When the deflection temperature of the prepared sheet was lower than the deflection temperature of the sheet 4032D by −5 degrees Celsius or more, the heat resistance was considered to be “B”. When the deflection temperature of the prepared sheet was lower than the deflection temperature of the sheet 4032D by less than −5 degrees Celsius, the heat resistance was considered to be “C”.

TABLE 1

| | | Example 1 | Example 2 | Example 3 | Example 4 | Example 5 |
|---|---|---|---|---|---|---|
| Polylactic acid | Kind | Polylactic | Polylactic | Polylactic | Polylactic | Polylactic |
| | | acid A | acid B | acid A | acid A | acid A |
| Rate of polylactic acid relative to | | 100% by mass | 100% by mass | 100% by mass | 100% by mass | 100% by mass |
| total amount of organic matters | | | | | | |
| Filler | Kind | Magnesite | Magnesite | Magnesium | Precipitated | Talc |
| | | | | hydroxide | calcium | |
| | | | | | carbonate | |
| | Number average | 1.2 | 1.2 | 1.3 | 0.15 | 2.5 |
| | particle diameter (μm) | | | | | |
| Feed ratio (polylactic acid/filler) | | 90/10 | 90/10 | 90/10 | 90/10 | 90/10 |
| (% by mass) | | | | | | |
| Compressive | Kind | Carbon | Carbon | Carbon | Carbon | Carbon |
| fluid | | dioxide | dioxide | dioxide | dioxide | dioxide |
| | Supply amount | 10% by mass | 10% by mass | 10% by mass | 10% by mass | 10% by mass |
| | (relative to | | | | | |
| | polyactic acid) | | | | | |
| Kneading step | Temperature (° C.) | 130 | 130 | 130 | 130 | 130 |
| | Pressure (MPa) | 10 | 10 | 10 | 10 | 7 |
| Polylactic acid | Weight average | 205,000 | 190,000 | 210,000 | 208,000 | 215,000 |
| composition | molecular weight | | | | | |
| | (Mw) | | | | | |
| | Molecular weight | 1.78 | 1.75 | 1.74 | 1.79 | 1.74 |
| | distribution (Mw/Mn) | | | | | |
| | Amount of residual | 800 | 900 | 600 | 900 | 500 |
| | monomer (ppm) | | | | | |
| Evaluation | Heat resistance of | B | B | B | B | A |
| result | sheet | | | | | |

TABLE 2

| | | Example 6 | Example 7 | Example 8 | Example 9 | Example 10 |
|---|---|---|---|---|---|---|
| Polylactic acid | Kind | Polylactic | Polylactic | Polylactic | Polylactic | Polylactic |
| | | acid A | acid A | acid A | acid A | acid A |
| Rate of polylactic acid relative to | | 100% by mass | 100% by mass | 100% by mass | 100% by mass | 100% by mass |
| total amount of organic matters | | | | | | |
| Filler | Kind | Magnesite | Magnesite | Magnesite | Magnesite | Magnesite |
| | Number average | 1.2 | 1.2 | 1.2 | 1.2 | 1.2 |
| | particle diameter (μm) | | | | | |
| Feed ratio (polylaetic acid/filler) | | 90/10 | 90/10 | 99.5/0.5 | 80/20 | 60/40 |
| (% by mass) | | | | | | |
| Compressive | Kind | Carbon | Carbon | Carbon | Carbon | Carbon |
| fluid | | dioxide | dioxide | dioxide | dioxide | dioxide |
| | Supply amount | 10% by mass | 10% by mass | 10% by mass | 10% by mass | 10% by mass |
| | (relative to | | | | | |
| | polylactic acid) | | | | | |
| Kneading step | Temperature (° C.) | 150 | 110 | 110 | 110 | 110 |
| | Pressure (MPa) | 7 | 15 | 15 | 15 | 15 |
| Polylactic acid | Weight average | 184,000 | 211,000 | 215,000 | 196,000 | 178,000 |
| composition | molecular weight | | | | | |
| | (Mw) | | | | | |
| | Molecular weight | 1.96 | 1.75 | 1.78 | 1.80 | 1.86 |
| | distribution (Mw/Mn) | | | | | |
| | Amount of residual | 1500 | 800 | 500 | 900 | 3200 |
| | monomer (ppm) | | | | | |
| Evaluation | Heat resistance of | B | B | A | B | B |
| result | sheet | | | | | |

TABLE 3

| | | Example 11 | Example 12 | Example 13 |
|---|---|---|---|---|
| Polylactic acid | Kind | Polylactic | Polylactic | Polylactic |
| | | acid A | acid A | acid A |
| Rate of polylactic acid relative to | | 100% by mass | 100% by mass | 100% by mass |
| total amount of organic matters | | | | |
| Filler | Kind | Magnesite | Magnesite | Magnesite |
| | Number average | 1.2 | 1.2 | 1.2 |
| | particle diameter (μm) | | | |
| Feed ratio (polylactic acid/filler) | | 90/10 | 50/50 | 99.9/0.1 |
| (% by mass) | | | | |
| Compressive | Kind | Carbon dioxide/ | Carbon | Carbon |
| fluid | | dimethyl ether | dioxide | dioxide |
| | | (8:2) | | |
| | Supply amount | 10% by mass | 10% by mass | 10% by mass |
| | (relative to | | | |
| | polylactic acid) | | | |
| Kneading step | Temperature (° C.) | 80 | 110 | 110 |
| | Pressure (MPa) | 15 | 15 | 15 |
| Polylactic acid | Weight average | 222,000 | 168,000 | 221,000 |
| composition | molecular weight | | | |
| | (Mw) | | | |
| | Molecular weight | 1.75 | 1.95 | 1.78 |
| | distribution (Mw/Mn) | | | |
| | Amount, of residual | 400 | 2800 | 800 |
| | monomer (ppm) | | | |
| Evaluation | Heat resistance of | A | B | B |
| result | sheet | | | |

TABLE 4

| | | Comparative | Comparative | Comparative | Comparative |
|---|---|---|---|---|---|
| | | Example 1 | Example 2 | Example 3 | Example 4 |
| Polylactic acid | Kind | Polylactic | Polylactic | Polylactic | Polylactic |
| | | acid A | acid A | acid A | acid A |
| Rate of polylactic acid relative to | | 100% by mass | 100% by mass | 100% by mass | 100% by mass |
| total amount of organic matters | | | | | |
| Filler | Kind | Magnesite | Magnesite | Magnesite | Magnesite |
| | Number average | 1.2 | 1.2 | 1.2 | 1.2 |
| | particle diameter (μm) | | | | |
| Feed ratio (polylactic acid/filler) | | 90/10 | 90/10 | 30/70 | 40/60 |
| (% by mass) | | | | | |
| Compressive | Kind | None | Carbon | Carbon | Carbon |
| fluid | | | dioxide | dioxide | dioxide |
| | Supply amount | | 10% by mass | 10% by mass | 10% by mass |
| | (relative to | | | | |
| | polylactic acid) | | | | |
| Kneading step | Temperature (° C.) | 190 | 190 | 110 | 110 |
| | Pressure (MPa) | 0.5 | 3 | 15 | 15 |
| Polylactic acid | Weight average | 138,000 | 145,000 | 132,000 | 154,000 |
| composition | molecular weight | | | | |
| | (Mw) | | | | |
| | Molecular weight | 2.15 | 2.12 | 2.05 | 1.96 |
| | distribution (Mw/Mn) | | | | |
| | Amount of residual | 5400 | 2200 | 5800 | 4200 |
| | monomer (ppm) | | | | |
| Evaluation | Heat resistance of | C | C | C | C |
| result | sheet | | | | |

### Examples 14 and 15

Using a continuous kneading apparatus 101 presented in FIG. 4, polymerization reaction was performed while the filler was introduced.

In place of the polylactic acid resin pellet, lactide and lauryl alcohol as an initiator were added to a resin pellet supplying tank at a molar ratio of 800/1 (Example 14) or 1400/1 (Example 15). The raw materials of polylactic acid (lactide and the initiator) and the filler (magnesite) were supplied so that the total of the flow rate of the raw materials of polylactic acid and the flow rate of the filler (magnesite) would be 10 kg/hr. The flow rate of lactide was 9 kg/hr and the flow rate of magnesite as the filler was 1 kg/hr. After 0.9 kg/h (corresponds to 10% by mass relative to polylactic acid) of carbon dioxide as a compressive fluid was supplied thereto, 200 ppm (relative to the raw materials of polylactic acid) of tin octylate as a catalyst was added thereto, and the resultant was supplied to the polymerization area.

Temperatures of the respective zones were set as follows: the polymerization area: 190 degrees Celsius; the kneading area: 130 degrees Celsius; the pressure releasing area: 190 degrees Celsius; and the molding processing area: 190 degrees Celsius. Pressures of the respective zones were set as follows: from the compressive fluid supplying area to the kneading area: 10.0 MPa; the compressive fluid removing area: 0.5 MPa; and the T-die: 5 MPa. A thickness of the sheet was set to 300 micrometers.

The polylactic acid composition and the sheet obtained were evaluated for characteristics in the same manners as in the aforementioned Examples and Comparative Examples. Results are presented in Table 5.

TABLE 5

| | | Example 14 | Example 15 |
|---|---|---|---|
| Filler | Kind | Magnesite | Magnesite |
| | Number average | 1.2 | 1.2 |
| | particle diameter (μm) | | |
| Lactide/initiator ratio (molar ratio) | | 800/1 | 1400/1 |
| Feed ratio (lactide/filler) (% by mass) | | 90/10 | 90/10 |
| Rate of polylactic acid relative to | | 100% by mass | 100% by mass |
| total amount of organic matters | | | |
| Compressive | Kind | Carbon | Carbon |
| fluid | | dioxide | dioxide |
| | Supply amount | 10% by mass | 10% by mass |
| | (relative to | | |
| | polylactic acid) | | |
| Kneading step | Temperature (° C.) | 130 | 130 |
| | Pressure (MPa) | 10 | 10 |
| Polylactic acid | Weight average | 205,000 | 315,000 |
| composition | molecular weight | | |
| | (Mw) | | |
| | Molecular weight | 1.75 | 1.78 |
| | distribution (Mw/Mn) | | |
| | Amount of residual | 500 | 800 |
| | monomer (ppm) | | |
| Evaluation | Heat resistance of | B | A |
| result | sheet | | |

Aspects of the present disclosure are as follows, for example.

<1> A polylactic acid composition including:
polylactic acid; and
a filler,
wherein an amount of the filler in the polylactic acid composition is 50% by mass or less, and
the polylactic acid in the polylactic acid composition has a weight average molecular weight (Mw) of 150,000 or more and a molecular weight distribution (Mn/Mw) of 1.5 or more but 2.0 or less.

<2> The polylactic acid composition according to <1>,
wherein a rate of the polylactic acid is 60% by mass or more relative to a total amount of organic matters in the polylactic acid composition.

<3> The polylactic acid composition according to <1>or <2>,
wherein an amount of the filler is 0.1% by mass or more but 50% by mass or less.

<4> The polylactic acid composition according to any one of <1> to <3>,
wherein the filler has an alkali activity.

<5> The polylactic acid composition according to <4>,
wherein the filler having the alkali activity is a hydroxide of an element selected from the group consisting of Ca, Mg, Al, and Zn, a carbonate of an element selected from the group consisting of Ca, Mg, Al, and Zn, an oxide of an element selected from the group consisting of Ca, Mg, Al, and Zn, or a combination of the hydroxide, the carbonate, and the oxide.

<6> The polylactic acid composition according to <4> or <5>,
wherein the filler having the alkali activity is at least one selected from the group consisting of calcium hydroxide, calcium carbonate, calcium oxide, magnesium hydroxide, magnesium carbonate, magnesium oxide, aluminum hydroxide, aluminum carbonate, and aluminum oxide.

<7> The polylactic acid composition according to any one of <1> to <6>,
wherein an amount of a residual monomer in the polylactic acid composition is 5,000 ppm or less.

<8> A method for producing the polylactic acid composition according to any one of <1> to <7>, the method including
kneading the polylactic acid and the filler in a compressive fluid.

<9> The method for producing the polylactic acid composition according to <8>,
wherein the kneading is performed at a temperature that is equal to or lower than a melting point of the polylactic acid.

<10> The method for producing the polylactic acid composition according to <8> or <9>,
wherein the compressive fluid is carbon dioxide.

<11> A produced product including
the polylactic acid composition according to any one of <1> to <7>.

<12> The produced product according to <11>,
wherein the produced product is at least one selected from the group consisting of molded products, sheets, films, particles, fibers, and foamed bodies.

The polylactic acid composition according to any one of <1> to <7>, the method for producing the polylactic acid composition according to any one of <8> to <10>, and the produced product according to <11> or <12> can solve the conventionally existing problems and can achieve the object of the present disclosure.

### REFERENCE SIGNS LIST

1: resin pellet supplying tank

2: filler supplying tank

3: compressive fluid supplying tank (No. 1)

4: compressive fluid supplying tank (No. 2)

5: trap

6: vacuum pump

7: T-die

8: catalyst supplying tank

100: continuous kneading apparatus

101: continuous kneading apparatus

1. A polylactic acid composition comprising:
polylactic acid; and
a filler,
wherein an amount of the filler in the polylactic acid composition is 50% by mass or less, and the polylactic acid in the polylactic acid composition has a weight average molecular weight (Mw) of 150,000 or more and a molecular weight distribution (Mn/Mw) of 1.5 or more but 2.0 or less.

2. The polylactic acid composition according to claim 1,
wherein a rate of the polylactic acid is 60% by mass or more relative to a total amount of organic matters in the polylactic acid composition.

3. The polylactic acid composition according to claim 1, wherein an amount of the filler is 0.1% by mass or more but 50% by mass or less.

4. The polylactic acid composition according to claim 1, wherein the filler has an alkali activity.

5. The polylactic acid composition according to claim 4,
wherein the filler having the alkali activity is a hydroxide of an element selected from the group consisting of Ca, Mg, Al, and Zn, a carbonate of an element selected from the group consisting of Ca, Mg, Al, and Zn, an oxide of an element selected from the group consisting of Ca, Mg, Al, and Zn, or a combination of the hydroxide, the carbonate, and the oxide.

6. The polylactic acid composition according to claim 4, wherein the filler having the alkali activity is at least one selected from the group consisting of calcium hydroxide, calcium carbonate, calcium oxide, magnesium hydroxide, magnesium carbonate, magnesium oxide, aluminum hydroxide, aluminum carbonate, and aluminum oxide.

7. The polylactic acid composition according to claim 1, wherein an amount of a residual monomer in the polylactic acid composition is 5,000 ppm or less.

8. A method for producing the polylactic acid composition according to claim 1, the method comprising:
kneading the polylactic acid and the filler in a compressive fluid.

9. The method for producing the polylactic acid composition according to claim 8, wherein the kneading is performed at a temperature that is equal to or lower than a melting point of the polylactic acid.

10. The method for producing the polylactic acid composition according to claim 8, wherein the compressive fluid is carbon dioxide.

11. A produced product comprising the polylactic acid composition according to claim 1.

12. The produced product according to claim 11, wherein the produced product is at least one selected from the group consisting of molded products, sheets, films, particles, and fibers.

13. The produced product according to claim 12, wherein the produced product contains a foamed body.
